(19) United States
(12) Patent Application Publication
(10) Pub. No.: US 2021/0245795 A1
(43) Pub. Date: Aug. 12, 2021

(54) STEERING DEVICE

(71) Applicant: TOYOTA JIDOSHA KABUSHIKI KAISHA, Toyota-shi (JP)

(72) Inventor: Daisuke NAKATA, Seto-shi (JP)

(73) Assignee: TOYOTA JIDOSHA KABUSHIKI KAISHA, Toyota-shi (JP)

(21) Appl. No.: 17/119,158

(22) Filed: Dec. 11, 2020

(30) Foreign Application Priority Data
Feb. 11, 2020 (JP) 2020-021064

(51) Int. Cl. B62D 5/04; B62D 7/14

(52) U.S. Cl. CPC B62D 5/046; B62D 7/146; B62D 5/0418

(57) ABSTRACT

A steering device configured to steer one wheel of a vehicle, including: a steering knuckle which constitutes a part of a suspension apparatus and which is allowed to move upward and downward relative to a body of the vehicle, the steering knuckle holding the wheel such that the wheel is rotatable; an actuator including an electric motor as a drive source and configured to rotate the steering knuckle in dependence on a force generated by the electric motor so as to steer the wheel; and a controller configured to control a supply current to the electric motor for achieving steering of the wheel corresponding to a steering operation by a driver, wherein, after turn-off of an ignition switch of the vehicle, the controller executes an end process for stopping the steering device from operating while gradually decreasing the supply current to the electric motor.

### CROSS REFERENCE TO RELATED APPLICATION

The present application claims priority to Japanese Patent Application No. 2020-021064, which was filed on Feb. 11, 2020, the disclosure of which is herein incorporated by reference in its entirety.

### BACKGROUND

### Technical Field

The following disclosure relates to a steering device installed on a vehicle and configured to steer one of wheels of the vehicle.

### Description of Related Art

An ordinary steering device includes a pair of steering knuckles which rotatably hold right and left wheels and which are connected by a connecting member extending in a right-left direction. The steering device is configured to steer the right and left wheels together by moving the connecting member rightward and leftward. There has been recently proposed a steering device configured to independently steer one wheel by a force generated by an electric motor as disclosed in Patent Document 1 (Japanese Patent Application Publication No. 2013-103665), for instance. Such a steering device will be hereinafter referred to as “single-wheel independent steering device” where appropriate. The single-wheel independent steering device includes an actuator including an electric motor as a drive source and configured to rotate the steering knuckle in dependence on a force generated by the electric motor. By controlling a supply current to the electric motor, steering of the wheel corresponding to a steering operation by a driver is achieved.

### SUMMARY

There acts, on the steering knuckle that partly constitutes a suspension device, a load of a vehicle body that is shared or received by the wheel (hereinafter referred to as “shared body load” where appropriate), so that the steering knuckle receives a moment about a kingpin axis due to suspension geometry. The suspension geometry is a concept that includes suspension alignment, inclination of the kingpin axis, etc. In the ordinary steering device described above, the forces received by the steering knuckles that respectively hold the right and left wheels are balanced owing to the connecting member. Thus, the steering knuckles do not rotate unless the connecting member is moved. As for the single-wheel independent steering device, however, the steering knuckle rotates unless a moment that counters the moment described above is generated by the electric motor. That is, even if the wheel is located at a straight-traveling-state position, the wheel cannot keep located at the position unless an electric current is kept supplied to the electric motor. (The straight-traveling-state position is a rotational position of the wheel at which the wheel should be located in a state in which the vehicle travels straight.) In the meantime, the rotation of the steering knuckle, namely, a change in the steering amount of the wheel, causes a change in the position of the vehicle body in an up-down direction due to the suspension geometry. That is, a height position of the vehicle body undesirably changes. In this case, if the supply current to the electric motor is cut off to stop the vehicle from operating, the vehicle body may move downward abruptly. The utility of the single-wheel independent steering device can be enhanced by coping with such an event. Accordingly, one aspect of the present disclosure is directed to a single-wheel independent steering device having high utility.

In one aspect of the present disclosure, a steeling device configured to steer one wheel of a vehicle includes:
a steering knuckle which constitutes a part of a suspension apparatus and which is allowed to move upward and downward relative to a body of the vehicle, the steering knuckle holding the wheel such that the wheel is rotatable;
an actuator including an electric motor as a drive source and configured to rotate the steering knuckle in dependence on a force generated by the electric motor so as to steer the wheel; and
a controller configured to control a supply current to the electric motor for achieving steering of the wheel corresponding to a steering operation by a driver,
wherein, after turn-off of an ignition switch of the vehicle, the controller executes an end process for stopping the steering device from operating while gradually decreasing the supply current to the electric motor.

In the end process, the supply current to the electric motor is gradually decreased so as to stop the steering device from operating. In the steering device according to the present disclosure, the force of the electric motor, i.e., the force of the actuator, is gradually decreased by executing the end process, thus avoiding the abrupt downward movement of the vehicle body when the vehicle stops operating. In other words, the supply of the electric current to the electric motor can be cut off while preventing an abrupt change in the height position of the vehicle. Consequently, the steering device of the present disclosure is a highly useful single-wheel independent steering device.

### Various Forms

Basic control by the controller, namely, control for achieving steering of the wheel corresponding to the steering operation by the driver, may be executed as follows, for instance. A target steering position, which is a target of a steering position of the wheel, is determined based on the steering operation by the driver, and the supply current to the electric motor is controlled such that an actual steering position becomes equal to the target steering position. Specifically, based on a steering position deviation that is a deviation of the actual steering position from the target steering position, the supply current to the electric motor is determined according to a feedback control law. In a case where the wheel is steered to a certain steering position from a steering position in a straight traveling state of the vehicle (hereinafter referred to as “straight-traveling-state position” where appropriate), it is preferable, for maintaining the certain steering position, to supply an electric current to the electric motor, which electric current enables application, to the wheel, of a force that counters a force for returning the wheel to the straight-traveling-state position. (The force for returning the wheel to the straight-traveling-slate position may be regarded as “self-aligning torque”.) In other words, even in a state in which a degree of the steering operation by the driver docs not change, it is preferable to supply, to the electric motor, a maintaining current necessary for maintaining the steering position of the wheel at the target steering position. To this end, a gain for an integral term in the feedback control law is determined appropriately, for instance. The maintaining current functions also as a supply current for generating a force that counters the moment generated by the shared body load. (This moment will be hereinafter referred to as “shared-load-dependent moment” where appropriate).

Even if the supply current to the electric motor is gradually decreased, the decrease in the supply current causes a change in the height position of the vehicle (hereinafter referred to as “vehicle height” where appropriate). From the viewpoint of preventing one or more occupants in the vehicle from experiencing an unnatural or uncomfortable feeling, the end process is preferably executed in a state in which one or more occupants are not in the vehicle. In view of this, the controller preferably executes, in the end process, a gradually decreasing process for gradually decreasing the supply current to the electric motor when a set time elapses from a time point at which it is estimated that one or more occupants have already got out of the vehicle after turn-off of an ignition switch (hereinafter referred to as “IG switch” where appropriate). More preferably, the controller executes, in the end process, a gradually decreasing process for gradually decreasing the supply current to the electric motor when a set time elapses from a time point at which it is estimated that all of the occupants have already got out of the vehicle after turn-off of an ignition switch.

In some cases, however, the IG switch is turned off in a state in which at least a part of the occupants remains in the vehicle. If the end process is not executed until all of the occupants get out of the vehicle, the supply current needs to be given to the electric motor for a considerably long lime duration. The steering device of the present disclosure may be configured taking this situation into consideration. That is, the set time is defined as a first set time, and the gradually decreasing process is defined as a first gradually decreasing process. In a case where it is estimated that one or more occupants have not yet got out of the vehicle even though a second set time elapses after turn-off of the IG switch, specifically, in a case where it is estimated that all of the occupants have not yet got out of the vehicle even though a second set time elapses after turn-off of the IG switch, the controller preferably executes, in the end process, a second gradually decreasing process for gradually decreasing the supply current to the electric motor when the second set time elapses. In this case, in view of the fact that the end process is executed in a state in which at least a part of the occupants still remains in the vehicle, a gradient at which the supply current to the electric motor is gradually decreased in the second gradually decreasing process is preferably smaller than a gradient at which the supply current to the electric motor is gradually decreased in the first gradually decreasing process, for changing the vehicle height more gently. For instance, a first current-gradual-decrease gradient which is the gradient in the first gradually decreasing process may be determined such that the vehicle height becomes lower by an amount ranging from not less than 5 mm to not greater than 10 mm per one second. Further, a second current-gradual-decrease gradient which is the gradient in the second gradually decreasing process may be determined such that the vehicle height becomes lower by an amount ranging from not less than 1 mm to less than 5 mm per one second. Here, the current-gradual-change gradient means a current decrease amount per unit time.

In the above configuration in which the maintaining current is supplied to the electric motor, the shared body load decreases in a case where one or more occupants in the vehicle get out of the vehicle, and the maintaining current decreases accordingly. In view of this phenomenon, the controller may estimate that one or more occupants have already got out of the vehicle based on a change in the supply current to the electric motor. Such estimation is simple because it does not require any sensor such as a weight sensor other than a current sensor. For instance, such estimation may be made on condition that the supply current to the electric motor becomes equal to a supply current at a time when the wheel receives a shared body load in a state in which no occupants are in the vehicle. (The shared load in this state will be hereinafter referred to as “empty-state shared load” where appropriate.)

In the above configuration in which the controller executes the end process described above, when the IG switch of the vehicle is turned on or when it is estimated that the ignition switch is to be turned on, the controller preferably executes a start process in which the supply current to the electric motor is gradually increased for causing the steering position of the wheel to gradually get close to the target steering position so as to start to operate the steering device. Owing to the start process, one or more occupants in the vehicle are less likely to experience an unnatural or uncomfortable feeling that arises from a change in the vehicle height upon start-up of the vehicle. The estimation of turn-on of the ignition switch may be made based on a fact that the door of the driver's seat has been opened, for instance. The gradient for gradually increasing the supply current in the start process is determined such that the vehicle height becomes higher by an amount ranging from not less than 5 mm to not greater than 10 mm per one second. For appropriately executing the end process, the controller preferably executes the end process on condition that the steering operation by the driver is not currently being performed.

### BRIEF DESCRIPTION OF THE DRAWINGS

The objects, features, advantages, and technical and industrial significance of the present disclosure will be better understood by reading the following detailed description of an embodiment, when considered in connection with the accompanying drawings, in which:

FIG. 1 is a perspective view of a vehicle wheel mounting module including a steering device according to one embodiment;

FIG. 2 is a schematic view of a vehicle on which the wheel mounting module of FIG. 1 is mounted on each wheel;

FIG. 3 is a flowchart of a steering control program executed by a controller of the steering device;

FIG. 4 is a flowchart of a sub routine for a basic-supply-current determining process, the sub routine being a part of the steering control program;

FIG. 5 is a flowchart of a sub routine for a start process, the sub routine being a part of the steering control program; and

FIG. 6 is a flowchart of a sub routine for an end process, the sub routine being a part of the steering control program.

### DETAILED DESCRIPTION OF THE EMBODIMENT

Referring to the drawings, there will be explained below in detail a steering device according to one embodiment of the present disclosure It is to be understood that the present disclosure is not limited to the details of the following embodiment but may be embodied based on the forms described in Various Forms and may be changed and modified based on the knowledge of those skilled in the art.

### A. Hardware Structure of Steering Device and Wheel Mounting Module for Vehicle

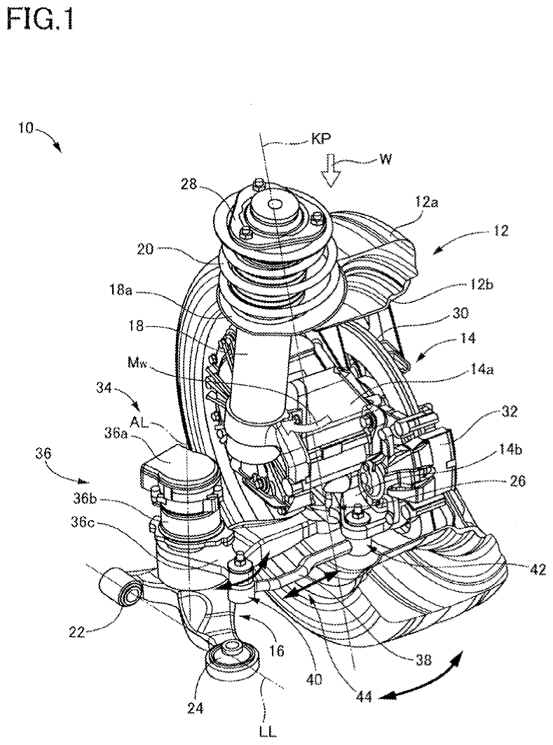

A steering device according to the embodiment is incorporated in a wheel mounting module 10 for a vehicle illustrated in FIG. 1. The wheel mounting module 10 will be hereinafter simply referred to as “module 10” where appropriate. The module 10 is for mounting, on a body of the vehicle, a wheel 12b to which a tire 12a is attached. Though the wheel 12b itself may be regarded as a wheel, the wheel 12b to which the tire 12a is attached is referred to as a wheel 12 in the present embodiment for convenience sake.

The module 10 includes a wheel drive unit 14 as a wheel driving and rotating device. The wheel drive unit 14 includes a housing 14a, an electric motor as a drive source and a speed reducer configured to reduce rotation of the electric motor (both of which are housed in the housing 14a and are not illustrated in FIG. 1), and an axle hub to which the wheel 12b is attached (The axle hub is hidden in FIG. 1.) The wheel drive unit 14 is disposed inside a rim of the wheel 12b The wheel drive unit 14 is what is called in-wheel motor unit. The wheel drive unit 14 is well known, and its explanation is dispensed with.

The module 10 includes a MacPherson-type suspension device (also referred to as a MacPherson strut type suspension device). In the suspension device, the housing 14a of the wheel drive unit 14 functions as a carrier which rotatably holds the wheel and which is allowed to move upward and downward relative to the vehicle body. Further, the housing 14a functions as a steering knuckle of a steering device and is allowed to move upward and downward relative to the vehicle body. The suspension device is constituted by a lower arm 16 as a suspension arm, the housing 14a of the wheel drive unit 14, a shock absorber 18, and a suspension spring 20.

The suspension device has an ordinary structure and will be briefly explained. The lower arm 16 is an L-shaped arm. A proximal end portion of the lower arm 16 is divided into two portions arranged in the front-rear direction of the vehicle. The lower arm 16 is supported at the proximal end portion thereof by a side member (not shown) of the vehicle body through a first bushing 22 and a second bushing 24 so as to be pivotable about ail arm pivot axis LL. A distal end portion of the lower arm 16 is pivotably coupled to a lower portion of the housing 14a of the wheel drive unit 14 through a ball joint 26, as a first joint, for use in coupling the lower arm 16. (The ball joint 26 will be hereinafter referred to as “first joint 26” where appropriate.)

The shock absorber 18 is fixedly supported at a lower end thereof to the housing 14a of the wheel drive unit 14 and is supported at an upper end thereof by an upper portion of a tire housing of the vehicle body through an upper support 28. The suspension spring 20 is supported at an upper end thereof by the upper portion of the tire the housing of the vehicle body through the upper support 28 and is supported at a lower end thereof by a lower support 18a in the form of a flange provided on the shock absorber 18. That is, the suspension spring 20 and the shock absorber 18 are disposed between the lower arm 16 and the vehicle body so as to be parallel to each other.

The module 10 includes a brake device. The brake device includes: a disc rotor 30 attached to the axle hub together with the wheel 12b and configured to rotate with the wheel 12; and a brake caliper 32 held by the housing 14a of the wheel drive unit 14 such that the brake caliper 32 straddles the disc rotor 30. Though not explained in detail, the brake caliper 32 includes: brake pads each as a friction member; and a brake actuator including an electric motor and configured to stop rotation of the wheel 12 by pushing the brake pads against the disc rotor 30 by the force of the electric motor. The brake device is an electric brake device configured to generate a broking force in dependence on the force generated by the electric motor.

The module 10 includes a steering device 34 according to the embodiment of the present disclosure. The steering device 34 is a single-wheel independent steering device for steering only one of a pair of right and left wheels 12 independently of the other of the right and left wheels 12. The steering device 34 includes the housing 14a of the wheel drive unit 14 functioning as the steering knuckle, a steering actuator 36 provided on the lower arm 16 at a position close to the proximal end portion of the lower arm 16, and a tie rod 38 coupling the steering actuator 36 and the steering knuckle 14a. The housing 14a of the wheel drive unit 14 will be referred to as “steering knuckle 14a” when treated as a constituent element of the steering device 34.

The steering actuator 36 includes a steering motor 36a that is an electric motor as a drive source, a speed reducer 36b for decelerating rotation of the steering motor 36a, and an actuator aim 36c configured to be pivoted by the rotation of the steering motor 36a decelerated by the speed reducer 36b and functioning as a pitman arm. A proximal end portion of the tie rod 38 is coupled to the actuator arm 36c through a hall joint 40, as a second joint, for use in coupling the proximal end portion of the tie rod 38. (The ball joint 40 will be hereinafter referred to as “second joint 40” where appropriate.) A distal end portion of the tie rod 38 is coupled to a knuckle arm 14b of the steering knuckle 14a through a ball joint 42, as a third joint, for use in coupling the distal end portion of the tie rod 38. (The ball joint 42 will be hereinafter referred to as “third joint 42” where appropriate.)

In the steering device 34, a line connecting the center of the upper support 28 and the center of the first joint 26 is a kingpin axis KP. By the motion of the steering motor 36a, the actuator arm 36c of the steering actuator 36 pivots about an actuator axis AL as indicated by a bold arrow in FIG. 1, and the pivotal movement of the actuator arm 36c is transmitted to the steering knuckle 14a by the tie rod 38, so that the steering knuckle 14a is rotated about the kingpin axis KP. That is, the wheel 12 is steered as indicated by a bold arrow in FIG. 1. Thus, the steering device 34 includes a motion converting mechanism 44 constituted by the actuator arm 36c. the tic rod 38, the knuckle arm 14b, etc. for converting the rotating motion of the steering motor 36a into the steering motion of the wheel 12.

In the steering device 34, the steering actuator 36 is disposed on the lower arm 16. Thus, a work of mounting the module 10 on the vehicle body can be easily performed. That is, the proximal end portion of the lower arm 16 is attached to the side member of the vehicle body, and the upper support 28 is attached to the upper portion of the the housing of the vehicle body, whereby the module 10 is mounted on the vehicle. In other words, the module 10 is excellent in mountability on the vehicle.

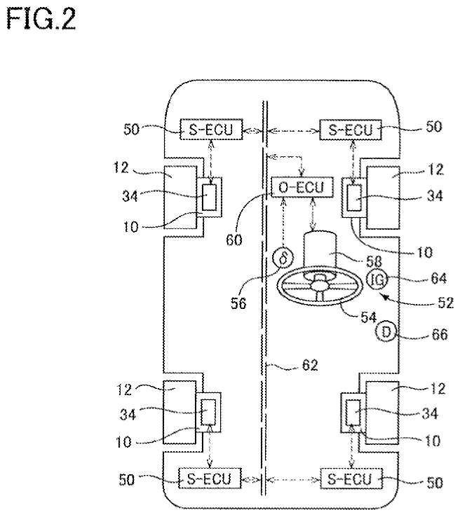

As schematically illustrated in FIG. 7, the module 10 can be provided for each of the four wheels 12, i.e., the front right and left wheels 12 and the rear right and left wheels 12. In the present vehicle, the steering devices 34 of the respective four modules 10 are controlled independently of each other by respective steering electronic control units 50 each as a controller. (Each steering electronic control unit is abbreviated as “steering ECU” and indicated as “S-ECU” in FIG. 2.) Specifically, the steering ECU 50 controls the steering motor 36a of the steering device 34 of the corresponding module 10, namely, the steering ECU 50 controls The supply current to the corresponding steering motor 36a. Thus, it is to be understood that the steering device 34 includes the steering ECU 50. In this respect, the steering ECU 50 is constituted by a computer including a CPU, a ROM, a RAM, etc., and a drive circuit of the steering motor 36a. The drive circuit of the steering motor 36a is an inverter in a case where the steering motor 36a is a brushless DC motor.

In the present embodiment, it is to be understood that the vehicle is equipped with a steering system including the four steering devices 34 that respectively correspond to the four wheels 12. The steering system is what is called steer-by-wire steering system. The steering system includes, as its constituent element, an operation device 52 for receiving a steering operation by the driver. The operation device 52 includes: a steering wheel 54 as a steering operation member; a steering sensor 56 for detecting an operation angle (rotation angle) of the steering wheel 54 as an operation amount of the steering operation member; a reaction-force applying device 58 configured to apply an operation reaction force to the steering wheel 54; and an operation electronic control unit 60 as a controller of the operation device 52. (The operation electronic control unit is abbreviated as “operation ECU” and indicated as “O-ECU” in FIG. 2.) The steering ECUs 50 and the operation ECU 60 are connected to a car area network or controllable area network (CAN) 62 and communicable with each other via the CAN 62.

The vehicle is equipped with an ignition switch 64 (hereinafter abbreviated as “IG switch 64” where appropriate) for starting and stopping the operation of the vehicle. The state of the IG switch 64, i.e., an on/off state, is recognized by the steering ECU 50 and the operation ECU 60. The vehicle is further equipped with a door sensor 66 for detecting an open/close state of a door of a driver's seat. The open/close state of the door detected by the door sensor 66 is also recognized by the steering ECU 50 and the operation ECU 60.

### B. Control of Steering Device

### i) Basic Control

The steering ECU 50 of the steering device 34 obtains, as a degree of the steering operation by the driver, the operation angle of the steering wheel 54 detected by the steering sensor 56, namely, a steering operation position δ. The steering ECU 50 obtains the steering operation position δ from the operation ECU 60 via the CAN 62. Based on the obtained steering operation position δ, the steering ECU 50 determines a target steering position Ψ* that is a steering position Ψ of the wheel 12 to be attained. Further, the steering ECU 50 controls a supply current I to the steering motor 36a such that the steering position Ψ of the wheel 12 becomes equal to the target steering position Ψ*. Here, a position of the steering wheel 54 for causing the vehicle to travel straight is defined as a straight-traveling-state position of the steering wheel 54. In this case, the steering operation position δ is regarded as a position change amount from the straight-traveling-state position, namely, a steering operation amount of the steering wheel 54. Further, the steering position of the wheel 12 is a synonym tor a steering angle of the wheel 12. Here, a position of the wheel 12 at which the wheel 12 should be located in a straight traveling state of the vehicle is defined as a straight-traveling-state position of the wheel 12. In this case, the steering position of the wheel 12 is regarded as a phase change amount from the straight-traveling-state position, namely, a steering amount of the wheel 12. In place of the steering operation position δ, there may be employed, as the degree of the steering operation by the driver, a torque that the driver applies to the steering wheel 54, i.e., a steering operation force. The target steering position Ψ* may be determined based on the steering operation force. Though not explained in detail, in a case where the wheel 12 is steered by automated driving, the steering ECU 50 may obtain the target steering position Ψ* based on information from an automated driving system. In this case, the wheel 12 is steered based on the obtained target steering position Ψ*.

A required steering torque Tq, which is a force of the actuator 36 necessary for steering the wheel 12 to the target steering position Ψ* or for maintaining the wheel 12 at the target steering position Ψ*, is determined based on a deviation of an actual steering position Ψ with respect to the target steering position Ψ*, namely, a steering position deviation ΔΨ. The steering device 34 is not equipped with a steering position sensor for detecting the actual steering position Ψ. Accordingly, the required steering torque Tq is determined based on a motion position of the steering motor 36a utilizing a specific relationship between the steering position Ψ of the wheel 12 and the motion position of the steering motor 36a. The steering motor 36a is a rotary-type motor. Accordingly, the motion position of the steering motor 36a is an angular position of a motor shaft, i.e., a motor rotation angle θ. Further, the motion position of the motor is regarded as a motion amount of the motor. Specifically, the motion position of the motor is regarded as a change amount of the motion position of the motor from a reference motion position. The motor rotation angle θ is regarded as a displacement angle from a reference motor rotation angle θ₀. The motor rotation angle θ is accumulated over 360°. The reference motor rotation angle θ₀ as the reference motion position is set to a straight-traveling-stale motor rotation angle that is a position for causing the vehicle to travel straight, i.e., a straight-traveling-state position

In the steering device 34, the steering ECU 50 determines, based on the target steering position Ψ*, a target motor rotation angle θ* that is a target of the motor rotation angle θ. The steering motor 36a includes a motor rotation angle sensor (such as a Hall IC, a resolver or the like) for phase switching in electric current supply thereto. Based on the detection by the motor rotation angle sensor, the steering ECU 50 recognizes an actual motor rotation angle θ that is the motor rotation angle θ at the present time. (The steering device 34 is configured such that, even when the IG switch 64 of the vehicle is in the off state, a minute current sufficient for recognizing the actual motor rotation angle θ is supplied to the motor rotation angle sensor and the steering ECU 50.) The steering ECU 50 obtains, as a motion position deviation, a motor rotation angle deviation Δθ that is a deviation of the motor rotation angle θ with respect to the target motor rotation angle θ*. Based on the motor rotation angle deviation Δθ(=θ°−θ), the steering ECU 50 determines the required steering torque Tq according to the following expression:

Tq=G_{P}·Δθ+G_{D}·(dΔθ/dt)+G_{I}·∫Δθdt.

The above expression is an expression according to a feedback control law based on the motor rotation angle deviation Δθ. The first term, the second term, and the third term in the expression are a proportional term, a derivative term, and an integral term, respectively. Further, G_{P}, G_{D}, and G_{I} represent a proportional gain, a derivative gain, and an integral gain, respectively.

The required steering torque Tq and the supply current I to the steering motor 36a are in a specific relationship relative to each other. Specifically, the required steering torque Tq depends on the force generated by the steering motor 36a, and the required steering torque Tq and the supply current I are generally proportional to each other. Accordingly, the steering ECU 50 determines the supply current I to the steering motor 36a based on the required steering torque Tq determined as described above and supplies the current I to the steering motor 36a.

When the vehicle is traveling with the wheel 12 steered, a self-aligning torque based on the suspension geometry acts on the module 10, in other words, a force to cause the wheel 12 to be located at the straight-traveling-state position acts on the module 10. For maintaining the wheel 12 at the target steering position it is needed to supply some current I to the steering motor 36a. This current I will be hereinafter referred to as “maintaining current” where appropriate. The above expression for determining the required steering torque Tq includes the integral term. By setting the integral gain G_{I} to an appropriate value and determining the required steering torque. Tq according to the above expression, a maintaining torque for maintaining the wheel 12 at the target steering position Ψ* is determined automatically. Thus, the maintaining current is determined automatically based on the maintaining torque.

The supply current I may be indirectly determined based on the motor rotation angle deviation Δθ using the required steering torque Tq as described above. The supply current I may be directly determined based on the motor rotation angle deviation Δθ according to the following expression without using the required steering torque Tq:

I=G_{P}′·Δθ+G_{D}′·(dΔθ/dt)+G_{I}′·∫Δθdt

In the above expression G_{P}′, G_{D}′, and G_{I}′ represent a proportional gain, a derivative gain, and an integral gain, respectively.
ii) Shared-Load-Dependent Moment and Measure for Coping with Shared-Load-Dependent Moment

As indicated by a white arrow in FIG. 1, a load W of the vehicle body that is received or shared by the wheel 12 acts on the steering knuckle 14a of the module 10. The load W will be hereinafter referred to as “shared body load W” where appropriate. Due to the shared body load W that acts on the steering knuckle 14a, the steering knuckle 14a receives a moment M_{W} about the kingpin axis KP (as indicated by a white arrow in FIG. 1) generated arising from the suspension geometry. The moment M_{W} will be hereinafter referred to as “shared load-dependent moment M_{W}” where appropriate. For maintaining the steering position v of the wheel 12 at the target steering position Ψ*, therefore, the actuator 36 needs to keep generating a force against the shared-load-dependent moment Mw even when the vehicle is at a stop, in other words, even when the vehicle is not traveling and the self-aligning torque is not acting on the wheel 12. That is, even if the target steering position Ψ* is the straight-traveling-state position, the maintaining current for countering the shared-load-dependent moment M_{W} must be kept supplied to the steering motor 36a. As described above, the required steering torque Tq is determined according to the above expression. Thus, the maintaining torque for countering the shared-load-dependent moment M_{W} is automatically supplied to the steering motor 36a without executing any specific control, like the maintaining current for countering the self-aligning torque.

In a state in which the vehicle is not operated, it is desirable to stop the current supply to the steering motor 36a in terms of power saving. It is thus considered that the current supply to the steering, motor 36a is cut off as soon as the IG switch 64 of the vehicle is turned off. If the current supply to the steering motor 36a is cut off, however, the maintaining current for countering the shared-load-dependent moment M_{W} stops from being supplied, so that the wheel 12 is inevitably steered by the shared-load-dependent moment M_{W}. In some cases, the steering knuckle 14a is inevitably rotated to such an extent that the steering knuckle 14a comes into contact with a steering stopper (not shown) for restricting a steering range. Steering of the wheel 12 involves a change in the height position of the vehicle body, i.e., a change in the vehicle height, due to the suspension geometry. Consequently, abrupt cutting off of the supply current I to the steering motor 36a causes abrupt steering of the wheel 12 and accordingly causes an abrupt downward movement of the vehicle body as the abrupt change in the vehicle height. Such abrupt steering of the wheel 12 and abrupt downward movement of the vehicle body give not a little impact to the steering device 34 and the module 10.

To avoid the abrupt steering of the wheel and the abrupt downward movement of the vehicle body, the steering device 34 is configured such that, after turn-off of the 10 switch 64, the steering ECU 50 executes an end process for gradually decreasing the supply current I to the steering motor 36a so as to stop the steering device 34 from operating. The end process is executed on conditions that the vehicle is not traveling, namely, a vehicle running speed v identified based on information from the brake system (not shown) is 0 and that the steering operation b not currently being performed. (The vehicle running speed v will be hereinafter referred to as “vehicle speed v” where appropriate.) In this respect, it is identified that the steering operation is not being currently performed when an operation speed dδ/dt of the steering wheel 54 sent from the operation ECU 60 as operation information is equal to 0.

The end process will be explained in detail. If the vehicle body moves downward in a state in which one or more occupants are still in the vehicle, the occupant or occupants experiences/experience an unnatural or uncomfortable feeling. In view of this, a gradually decreasing process for gradually decreasing the supply-current I to the steering motor 36a is not executed, in principle, until one of set conditions is satisfied after the end process is started. The supply current I is preferably gradually decreased in the end process on condition that all of the occupants have got out of the vehicle, namely, on condition that the vehicle is empty. Taking this into consideration, the steering ECU 50 estimates the shared body load W based on the supply current I (the maintaining current) to the steering motor 36a determined after the end process has started. Further, when a first set time t₁ elapses from a time point at which the shared body load W becomes equal to or less than an empty-state shared load W₀, the steering ECU 50 gradually decreases, to 0, the supply current I to the steering motor 36a at a first current-gradual-decrease gradient dI_{DEC1} that is set to achieve a comparatively gentle downward movement of the vehicle body. Here, the empty-state shared load W₀ is a shared body load W in a slate in which no occupants are in the vehicle, and the first set time t₁ is a time in which the occupants having got out of the vehicle are estimated to move away from the vehicle by a certain distance.

It can be, however, expected that the IG switch 6r is turned off to stop the vehicle from operating in a state in which at least a part of the occupants is still in the vehicle. Thus, even if the shared body load W is not yet equal to or less than the empty-state shared load W₀, the steering ECU 50 executes a second gradually decreasing process, different from the first gradually decreasing process, that is a gradually decreasing process for gradually decreasing the supply current I, on condition that a second set time t₂ elapses from a time point at which the end process is started. Here, the second set time t₂ is a time set in view of a fact that supplying the current I to the steering motor 36a for a considerably long lime is not desirable in terms of power saving. In the second gradually decreasing process, the steering ECU 50 gradually decreases, to 0, the supply current I to the steering motor 36a at a second current-gradual-decrease gradient dI_{DEC2} when the second set time t₂ elapses. The second current-gradual-decrease gradient dI_{DEC2} is set such that one or more occupants in the vehicle do not experience an unnatural or uncomfortable feeling with respect to the downward movement of the vehicle body. In accordance with a difference in purpose between the first gradually decreasing process and the second gradually decreasing process, the second current-gradual-decrease gradient dI_{DEC2} is set so as to be smaller than the first current-gradual-decrease gradient dI_{DEC1}.

In the steering device 34, at a time point at which the IG switch 64 is turned on for starting to operate the vehicle, there are cases in which the steering position Ψ of the wheel 12 is not equal to the target steering position Ψ* determined at that time point as a result of execution of the end process described above. When the steering position deviation ΔΨ(=Ψ*−Ψ) is large to a certain extent, it is expected that the vehicle body abruptly moves upward due to an abrupt change in the steering position Ψ. This upward movement of the vehicle body also causes one or more occupants in the vehicle to fed an unnatural or uncomfortable feeling. Thus, when the IG switch 64 is turned on or when it is estimated that the IG switch 64 is to be turned on, the steering ECU 50 of the steering device 34 executes a start process in which the supply current I to the steering motor 36a is gradually increased for causing the steering position Ψ of the wheel 12 to gradually get close to the target steering position Ψ*. Specifically, the situation in which it is estimated that the IG switch 64 is to be turned on means a situation in which the door sensor 66 for detecting opening and closing of the door of the driver's seat detects that the door has been opened.

In the start process, the steering ECU 50 sets an arriving current I₀, at which the supply current I should arrive in the start process, to be equal to the supply current I to the steering motor 36a determined in the basic control at a start time point of the start process. The steering ECU 50 then gradually increases, as the gradually increasing current I_{INC}, the supply current I up to the arriving current I₀ at a current gradual-increase gradient dI_{INC}. The current gradual-increase gradient dI_{INC} is set such that the gradually increasing current I_{INC} arrives at the arriving current I₀ as soon as possible within a range in which one or more occupants in the vehicle do not feel unnatural or uncomfortable feeling with respect to the upward movement of the vehicle body.

iii) Flow of Steering Control

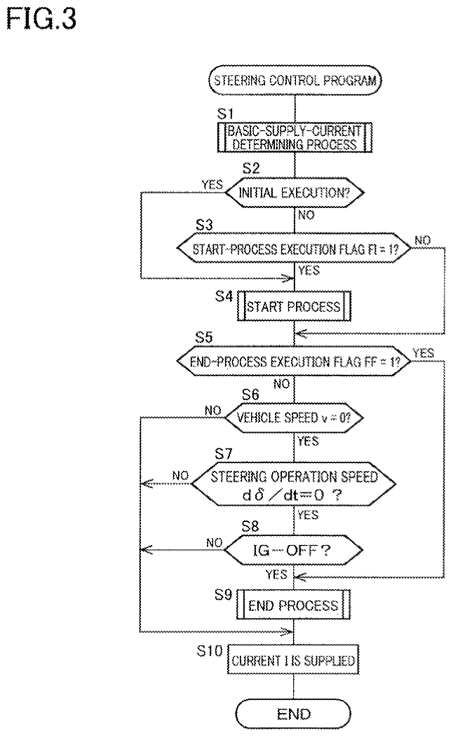

The computer of the steering ECU 50, as a controller, repeatedly executes a steering control program indicated by a flowchart of FIG. 3 at a short time pitch, e.g., about several to several tens of milliseconds (msec), so that the control of the steering device 34 including the basic control, the end process, the start process, namely, the control of the supply current I to the steering motor 36a, is executed. Hereinafter, there will be briefly explained a flow of processing according to the steering control program referring to the flowchart. In a strict sense, each of the steering position Ψ and the motor rotation angle θ takes a positive value or a negative value depending on toward which one of the inner side and the outer side of the vehicle the wheel is steered with respect to the straight-traveling-state position, namely, depending on the direction of steering of the wheel 12. Similarly, the direction of the supply current I to the steering motor 36a is forward or reverse, namely, the value of the direction of the supply current I is positive or negative, depending on the direction of the steering of the wheel 12. For brevity of explanation, those are treated as being positive irrespective of the direction of steering of the wheel 12.

On condition that the IG switch 64 is turned on or on condition that it is detected based on detection of the door sensor 66 that the door of the driver's scat has been opened in a state in which the IG switch 64 is in the off state, the steering ECU 50 wakes up from a sleep mode, and the steering control program starts to be executed.

When the program starts to be executed, a basic-supply-current determining process is initially executed at Step 1. (Hereinafter, Step S1 is abbreviated as “S1 ”, and other steps will be similarly abbreviated.) As later explained in detail, the basic-supply-current determining process is for determining, based on the operation position δ of the steering wheel 54, the current I to be supplied to the steering motor 3a.

At S2, it is determined whether execution of the program is started this time, namely, whether current execution of the program is initial execution. When the current execution of the program is initial execution, the start process is executed at S4. As later explained in detail, the start process is for gradually increasing the supply current I to the steering motor 36a for starting to operate the steering device 34. Even if the current execution of the program is net initial execution, the start process at S4 is executed when it is determined at S3 that a start-process execution flag FI is “1”. The start-process execution flag FI, whose initial value is “0”, is set to “1” when the start process is under execution, in other words, when the start process should continue to be executed. When it is determined at S3 that the start-process execution flag FI is not the start process at S4 is skipped.

When the start process is ended and when the start process is skipped, the control flow proceeds to S5 at which it is determined whether an end-process execution flag FF is “1”, the end-process execution flag FF, whose initial value is “0”, is set to “1” when the end process is under execution, in other words, the end process should continue to be executed. As later explained in detail, the end process is for gradually decreasing the supply current I to the steering motor 36a for stopping the operation of the steering device 34. When it is determined that the end-process execution flag FF is not “1”, it is determined at S6-S8 whether the conditions for starting the end process are satisfied. Specifically, it is determined at S6 whether the vehicle speed v is 0, namely, whether the vehicle is at a stop. It is determined at S7 whether the operation speed dδ/dt of the steering wheel 54 is 0, namely, whether the steering operation is being performed by the driver. It is determined at S8 whether the IG switch 64 is in the off state. When i) the vehicle is at a stop, ii) the steering operation is not being performed, and iii) the IG switch 64 is in the off state, all of the conditions for starting the end process are satisfied and the end process is executed at S9. When it is determined at S5 that the end-process execution flag FF is “1”, S6-S8 are skipped. On the other hand, when it is determined at S6-S8 that the conditions for stating the end process are not satisfied, the end process at S9 is skipped.

At S10, any one of the supply current I determined in the basic-supply current determining process at S1; the supply current I that is gradually increased in the start process at S4; and the supply current I that is gradually decreased in the end process at S9 is supplied to the steering motor 36a. Thus, one execution of the program is ended.

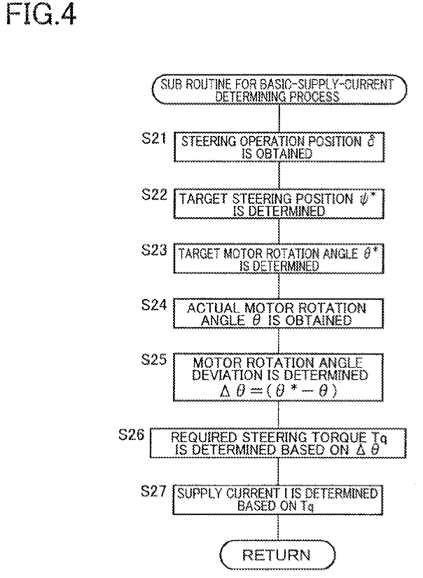

The basic-supply-current determining process at S1 is executed by executing a sub routine for the basic-supply-current determining process indicated by a flowchart of FIG. 4. Referring to the sub routine, the basic-supply-current determining process will be explained. In the basic-supply-current determining process, the operation position δ of the steering wheel 54 is obtained at S21 based on detection by the steering sensor 56. At S22, the target steering position Ψ* is determined based on the obtained operation position δ. At S23, the target motor rotation angle θ* is determined based on the target steering position Ψ* determined at $22. At S24, the actual motor rotation angle θ is obtained based on detection by the motor rotation angle sensor. At S25, the motor rotation angle deviation Δθ is determined based on the target motor rotation angle θ* determined at S23 and the actual motor rotation angle θ obtained at S24. At S26, the required steering torque Tq is determined based on the motor rotation angle deviation Δθ determined at S25 according to the feedback control law explained above. At S27, the current I to be supplied to the steering motor 36a is determined based on the required steering torque Tq determined as S26. Thus, the processing according to the sub routine is ended.

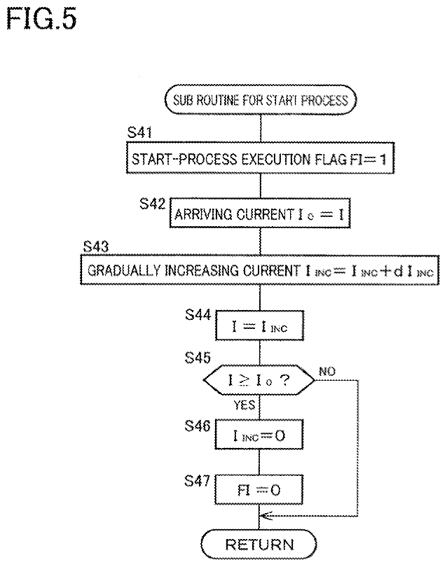

The stun process at S4 is executed by executing u sub routine for the start process indicated by a flowchart of FIG. 5. The start process will be explained referring to the sub routine. In the start process, the value of the start process execution flag FI is set to “1” at S41. At S42, the arriving current I₀, at which the supply current I should arrive after having been gradually increased, is set to be equal to the supply current I currently determined in the basic-supply-current determining process. At S43, the gradually increasing current which is the supply current I being gradually increased, is increased by an amount corresponding to the current gradual-increase gradient dI_{INC}. Here, the current gradual-increase gradient di_{INC} is an increase amount of the supply current I per the execution pitch of the program. It is noted that the gradually increasing current I_{INC} is equal to 0 at the start time point of the start process. After having been increased, the gradually increasing current I_{INC} is replaced with the supply current I at S44.

At S45, it is determined whether the supply current I arrives at the arriving current I₀. When the supply current I arrives at the arriving current I₀, the gradually increasing current I_{INC} is reset to 0 at S46 and the start-process execution flag FI is reset to “0” at S47. Thus, the execution of the sub routine is ended. That is, the execution of the start process is ended. When it is determined at S45 that the supply current I does not yet arrive at the arriving current I₀, S46 and S47 are skipped. That is, the start process continues to be executed.

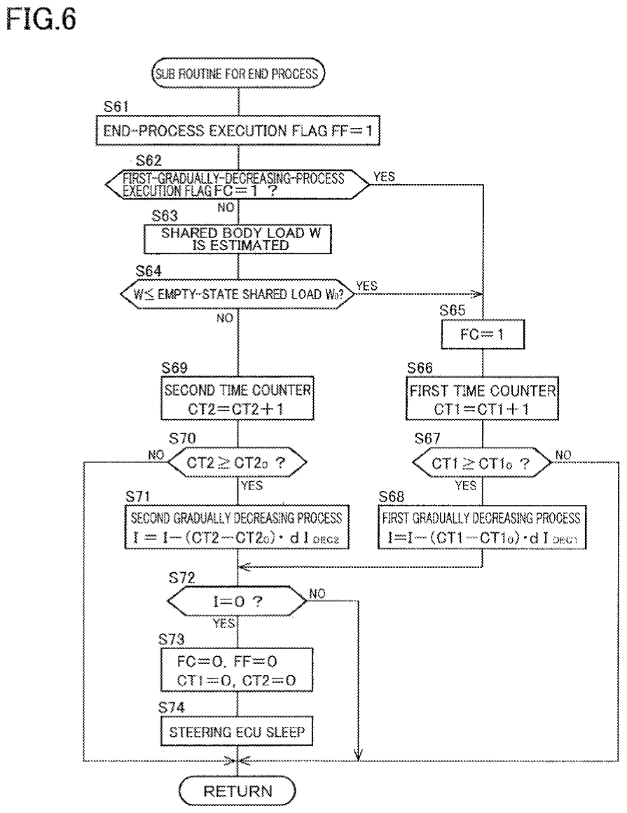

The end process at S9 is executed by executing a sub routine for the end process indicated by a flowchart of FIG. 6. The end process will be explained referring to the sub routine. In the end process, the value of the end-process execution flag FF is set to “1” at S61. As explained above, one of the first gradually decreasing process and the second gradually decreasing process is executed as the gradually decreasing process of the supply current I in the end process. Accordingly, it is determined at S62 whether a first-gradually-decreasing-process execution flag FC is “I”, five first-gradually-decreasing-process execution flag FC indicates whether the first gradually decreasing process is under execution. The first-gradually-decreasing-process execution flag FC, whose initial value is “0”, is set to “1” when the first gradually decreasing process is under execution (or the first gradually decreasing process should continue to be executed) or when execution of the first gradually decreasing process is on standby.

When it is determined at S62 that the value of the first-gradually-decreasing-process execution flag FC is not “1”, the shared body loud W received by the wheel 12 is estimated at S63 based on the supply current I determined in the basic-supply-current determining process. At S64, it is determined whether the estimated shared body load W is not greater than the empty-state shared load W₀. When the shared body load W is not greater than the empty-state shared load W₀, the first-gradually-decreasing-process execution flag FC is set to “1” at S65, and the first gradually decreasing process or a standby process for the first gradually decreasing process is executed at S66-S68. When it is determined at S62 that the first gradually decreasing process is under execution, the control flow proceeds to S65 and subsequent steps without executing S63, S64.

The first gradually decreasing process and the standby process for the first gradually decreasing process will be explained in detail. A first time counter CT1, whose initial value is 0, is provided for the first gradually decreasing process. At S66, the first time counter CT1 is incremented. At S67, it is determined whether the incremented value of the first time counter CT1 is not less than a first set value CT1₀. The first set value CT1₀ is set such that a product of the first set value CT1₀ and the execution pitch of the program is equal to the first set time t₁. When the value of the first time counter CT1 is not less than the first set value CT1₀, it is determined that the first set time t₁ elapses, in other words, it is determined that a certain time passes after all of the occupants have got out of the vehicle. In this case, the first gradually decreasing process is executed at S68. In the first gradually decreasing process, with a lapse of a further time from the first set time t₁, the supply current I determined in the basic-supply-current determining process is gradually decreased at the first current-gradual-decrease gradient dI_{DEC1}. Here, the first current-gradual-decrease gradient dI_{DEC1} is a decrease amount of the supply current I per the execution pitch of the program. When it is determined at S67 that the value of the first time counter CT1 is less than the first set value CT1₀, the execution of the sub routine is ended to stand by for the first gradually decreasing process at S68.

When it is determined at S64 that the shared body load W is greater than the empty-state shared load W₀. the second gradually decreasing process or a standby process for the second gradually decreasing process is executed at S69-S71. Specifically, a second time counter CT2, whose initial value is 0, is provided for the second gradually decreasing process. At S69, the second time counter CT2 is incremented. At S70, it is determined whether the incremented value of the second time counter CT2 is not less than a second set value CT2₀. The second set value CT2₀ is set such that a product of the second set value CT2₀ and the execution pitch of the program is equal to the second set time t₂. When the value of the second time counter CT2 is not less than the second set value CT2₀, it is determined that the second set time t₂ elapses, in other words, it is determined that a long time to a certain degree elapses after the end process has been started. In this ease, the second gradually decreasing process is executed at S71. In the second gradually decreasing process, with a lapse of a further time from the second set time t₂, the supply current I determined in the basic-supply-current determining process is gradually decreased at the second current-gradual-decrease gradient dI_{DEC2}. Here, the second current-gradual-decrease gradient dI_{DEC2} is a decrease amount of the supply current I per the execution pitch of the program. When it is determined at S70 that the value of the second time counter CT2 is less than the second set value CT2₀, the execution of the subroutine is ended.

When the supply current I is gradually decreased in the first gradually-decreasing process at S68 or in the second gradually decreasing process at S71, it is determined at S72 whether the supply current I has been gradually decreased to 0. When the supply current I becomes equal to 0, the control flow proceeds to S73 at which the value of the first-gradually-decreasing-process execution flag FC and the value of the end-process execution flag HP are respectively reset to “0” and the value of the first time counter CT1 and the value of the second time counter CT2 are respectively reset to 0. At S74, the steering ECU 50 goes into the sleep mode to stop execution of the steering control program. When it is determined at S72 that the supply current I is not equal to 0, the execution of the sub routine is ended to continue the end process by next execution of the program.

What is claimed is:

1. A steering device configured to steer one wheel of a vehicle, comprising:
a steering knuckle which constitutes a part of a suspension apparatus and which is allowed to move upward and downward relative to a body of the vehicle, the steering knuckle holding the wheel such that the wheel is rotatable;
an actuator including an electric motor as a drive source and configured to rotate the steering knuckle in dependence on a force generated by the electric motor so as to steer the wheel; and
a controller configured to control a supply current to the electric motor for achieving steering of the wheel corresponding to a steering operation by a driver,
wherein, after turn-off of an ignition switch of the vehicle, the controller executes an end process for stopping the steering device from operating while gradually decreasing the supply current to the electric motor.

2. The steering device according to claim 1,
wherein the controller is configured to:
determine, based on the steering operation by the driver, a target steering position that is a target of a steering position of the wheel; and
control the supply current to the electric motor such that a maintaining current, which is necessary for maintaining the steering position of the wheel at the target steering position, is supplied to the electric motor even in a state in which a degree of the steering operation by the driver does not change.

3. The steering device according to claim 1, wherein the controller executes, in the end process, a gradually decreasing process for gradually decreasing the supply current to the electric motor when a set time elapses from a lime point at which it is estimated that one or more occupants have already got out of the vehicle after turn off of the ignition switch.

4. The steering device according to claim 3,
wherein the set time is defined as a first set time, and the gradually decreasing process is defined as a first gradually decreasing process, and
wherein, in a case where it is estimated that one or more occupants have not yet got out of the vehicle even though a second set time elapses after turn-off of the ignition switch, the controller executes, in the end process, a second gradually decreasing process for gradually decreasing the supply current to the electric motor when the set second time elapses.

5. The steering device according to claim 4, wherein a gradient at which the supply current to the electric motor is gradually decreased in the second gradually decreasing process is smaller than a gradient at which the supply current to the electric motor is gradually decreased in the first gradually decreasing process.

6. The steering device according to claim 3, wherein the controller is configured to estimate that one or more occupants have already got out of the vehicle based on a change in the supply current to the electric motor.

7. The steering device according to claim 1, wherein the controller is configured to execute the end process on condition that the steering operation by the driver is not currently being performed.

8. The steering device according to claim 1,
wherein the controller is configured to determine, based on the steering operation by the driver, a target steering position that is a target of a steering position of the wheel; and
wherein, when the ignition switch of the vehicle is turned on or when it is estimated that the ignition switch is to be turned on, the controller executes a start process in which the supply current to the electric motor is gradually increased for causing the steering position of the wheel to gradually get close to the target steering position so as to start to operate the steering device.
